(19) United States
(12) Patent Application Publication
(10) Pub. No.: US 2003/0165350 A1
(43) Pub. Date: Sep. 4, 2003

(54) Reservoir pens and ink cartridges therefor

(76) Inventors: Roy Nicoll, Wokingham (GB); Jon Winter, Wokingham (GB)

Correspondence Address: MARSHALL, GERSTEIN & BORUN, 6300 SEARS TOWER, 233 SOUTH WACKER, CHICAGO, IL, 60606-6357, US

(21) Appl. No.: 10/220,136

(22) PCT Filed: Mar. 1, 2001
(86) PCT No.: PCT/GB01/00889

(30) Foreign Application Priority Data
Mar. 2, 2000 (GB) 0005080.7

(51) Int. Cl. B43K 5/18

(52) U.S. Cl. 401/235; 401/232

(57) ABSTRACT

An ink cartridge (1) for a reservoir pen has a body (2) which encloses an ink-chamber (3) that is initially sealed near the front end of the cartridge by a closure formed by a plug (4). The plug (4) sealingly engages in an axial bore (5) which is open to the front end of the cartridge and is slidably mounted in the cartridge body (2) so as to be moved reawardly by engagement with a peg (34) upon insertion of the cartridge (1) into a pen, thereby allowing ink flow from the ink chamber (3) through the bore (5) and to a writing tip (23) of a nib (22) of the pen. The peg (34) is sized so as to form a seal with the inner surface of the bore (5) when fully inserted thereinto.

This invention relates to reservoir pens and in particular to ink cartridges for use in reservoir pens. It is, of course, well known to provide reservoir pens adapted to receive ink cartridges which are replaced when they become emptied of ink.

In GB-A-2146588 there is described an ink cartridge with an internal valve assembly including a valve seat, and a valve member urged against the seat by a coil spring, the valve member being axially inwardly displaceable to open the valve to allow ink to flow out of the cartridge. Described in WO 01/64452 is an ink cartridge including an internal valve assembly including a valve seat and a resilient diaphragm separating a chamber, which is in communication with ambient atmosphere via an air port, and ink transfer chamber so that the diaphragm is deformed to open the ink path from the main ink chamber when there is a reduced pressure in the ink transfer chamber.

Provided in accordance with the present invention is an ink cartridge for a reservoir pen, comprising a body enclosing a chamber, an ink port through which, in use, ink delivered from the chamber is discharged from the cartridge, and a resilient valve element mounted on the body at the port for controlling flow of ink therethrough, the valve element having an open condition in which the port is opened, characterised in that the valve element is inwardly deformable.

By equipping an ink cartridge with a resilient valve element, in particular a moulded element formed of resiliently deformable material, the performance of a valve for controlling ink flow in the pen can easily be assured over a long term use of a reservoir pen since the valve element which may be susceptible to wear is then replaced each time a fresh ink cartridge is inserted into the pen. A valve for controlling ink flow to the pen nib can be desirable for example when a cartridge is adapted to hold a relatively large volume of ink.

The valve element which is carried by the cartridge body may be either a valve member for cooperation with a valve seat, in which case the seat can conveniently be defined by the cartridge body, or a valve seat in which case a valve member cooperable with the seat can be provided in the pen structure.

In one particular embodiment in which the valve member is carried by the cartridge, the valve member is integral with a spring which extends radially from the valve member and biases the valve member away from the seat. The outer end of die spring is attached to a support ring which extends around the valve member, there being openings for ink flow between the ring and valve member.

In a preferred embodiment of a cartridge having a valve element in the form of a valve seat, the valve seat comprises a disc with at least one aperture therein for ink to pass through when the valve is open.

The ink chamber is conveniently sealed at the forward end thereof by a closure which is opened on insertion of the cartridge into the pen in order to bring the discharge port into communication with the chamber. For this purpose the cartridge can have a bore into which a peg carried by the pen enters when the cartridge is loaded into the pen. In addition to opening the closure, e.g. by rupturing a closure diaphragm or displacing a closure plug, the peg conveniently serves to define an ink feed duct for conducting ink from the ink chamber to the discharge port, the peg being provided with a longitudinal groove for this purpose.

The foregoing and other preferred features of the invention will become clear from the following detailed description of some embodiments of the invention, reference being made to the accompanying drawings, in which:—

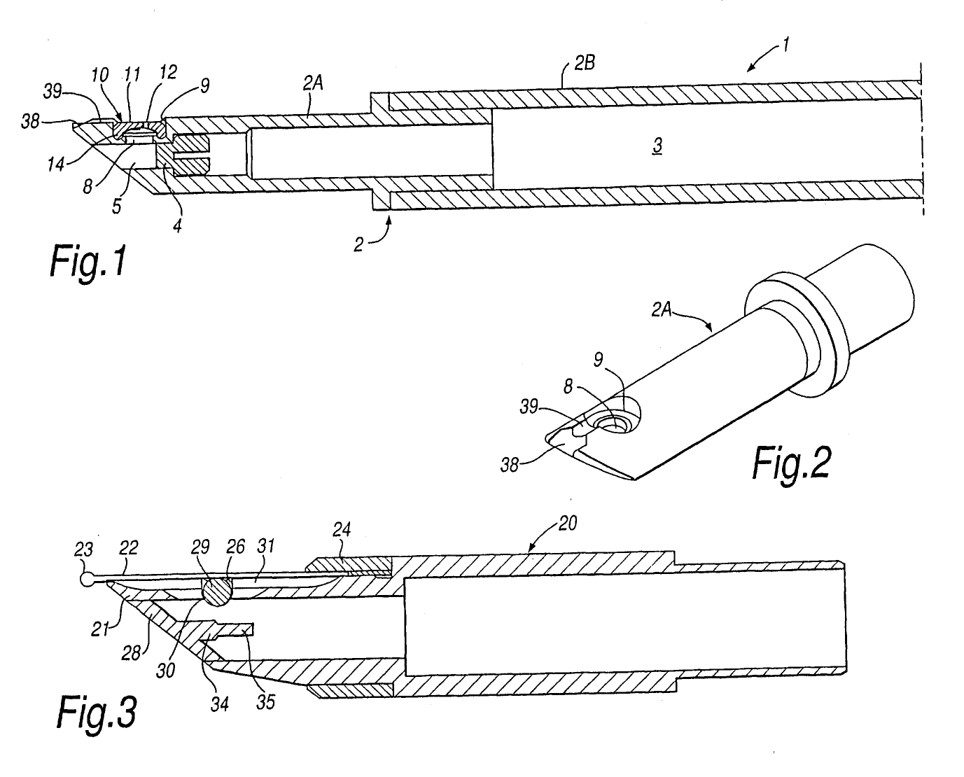

FIG. 1 is an axial cross-section through the forward end of an ink cartridge embodying the invention;

FIG. 2 is an isometric view showing the front end part of cartridge of FIG. 1;

FIG. 3 is an axial cross-section through a pen with which the cartridge of FIG. 1 is intended to be used;

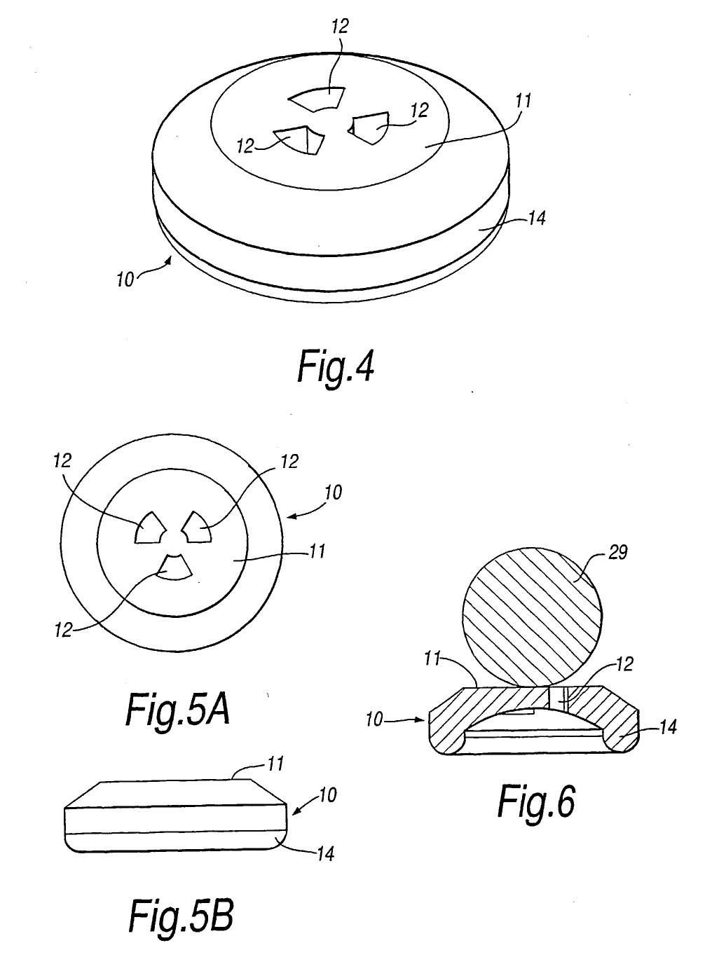

FIG. 4 is an isometric view showing the valve seat of the cartridge shown in FIG. 1;

FIGS. 5A and 5B show the valve seat of FIG. 4 in plan and side elevation, respectively;

FIG. 6 is a cross-sectional view showing the valve seat in combination with the valve member of the pen;

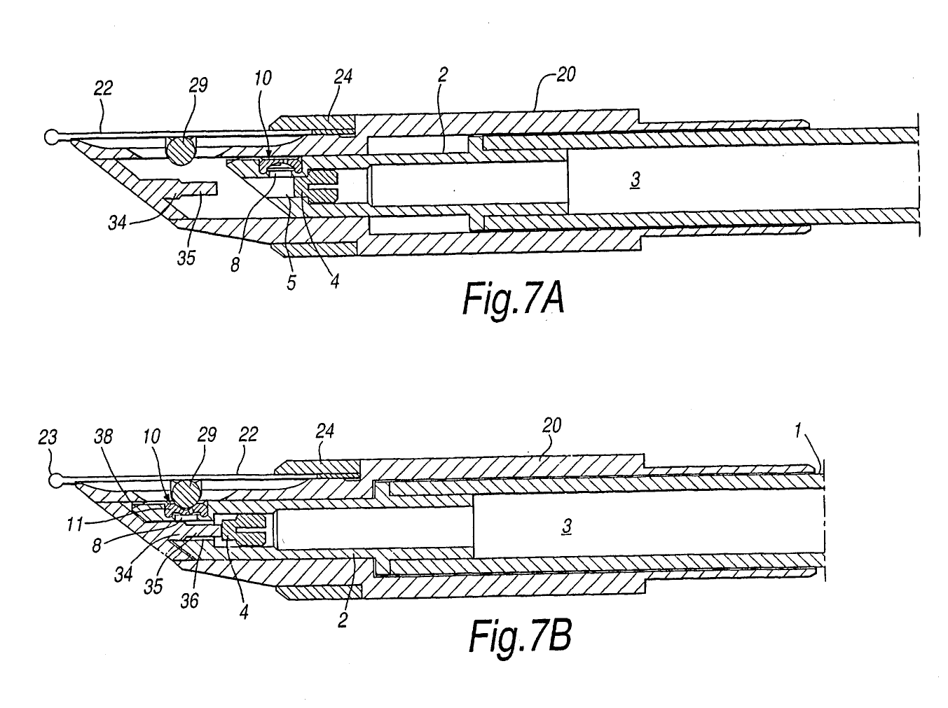

FIGS. 7A and 7B are axial cross-sections showing the cartridge of FIG. 1 in the course of being loaded into the pen of FIG. 3, and inserted fully into the pen, respectively;

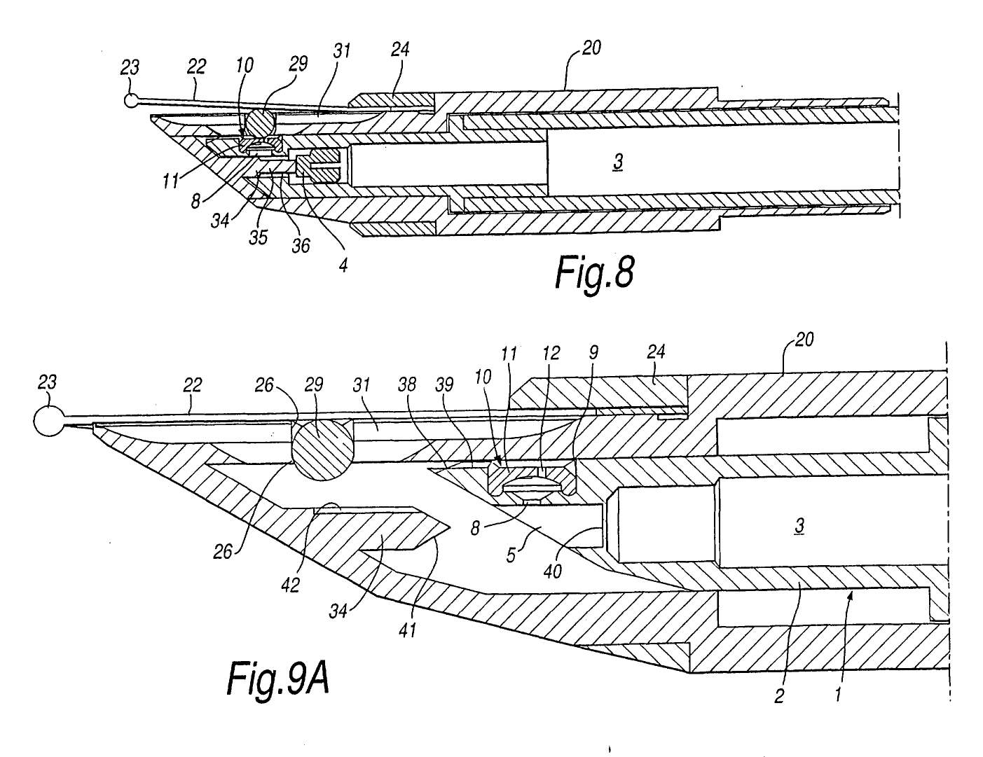

FIG. 8 is an axial cross-section corresponding to FIG. 7B, but illustrating a valve open condition of the pen;

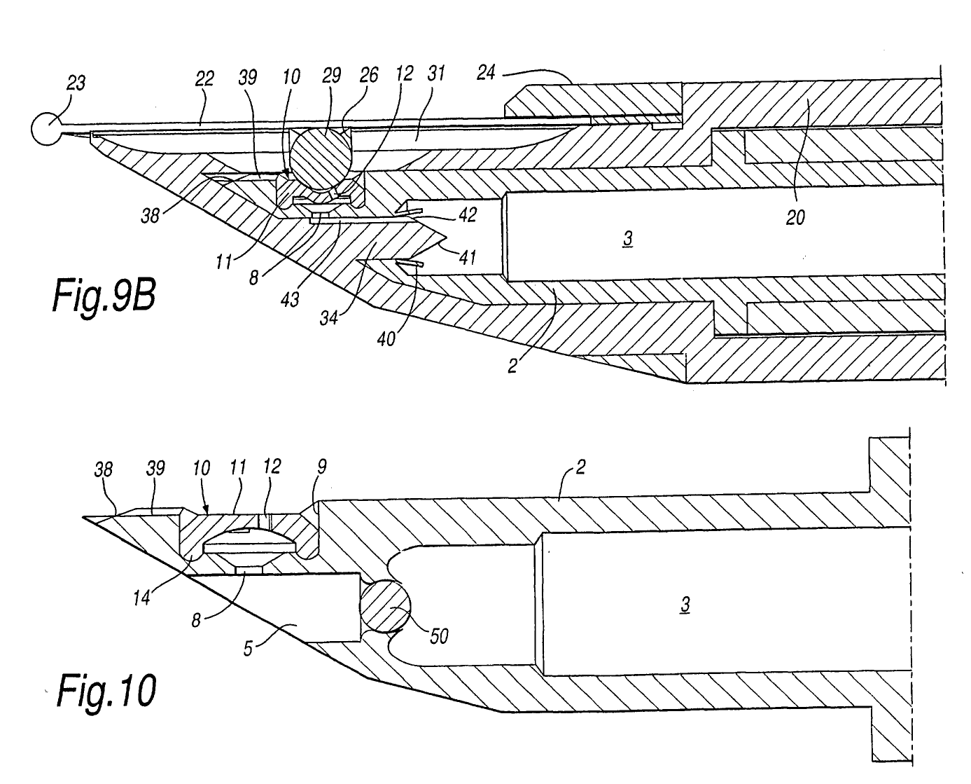

FIGS. 9A and 9B are axial cross-sections corresponding to FIGS. 7A and 7B, respectively and illustrating a modified form of cartridge in combination with a pen similar to that of FIG. 3.

FIG. 10 is an axial section through another cartridge suitable for use with the pen of FIGS. 9A and 9B;

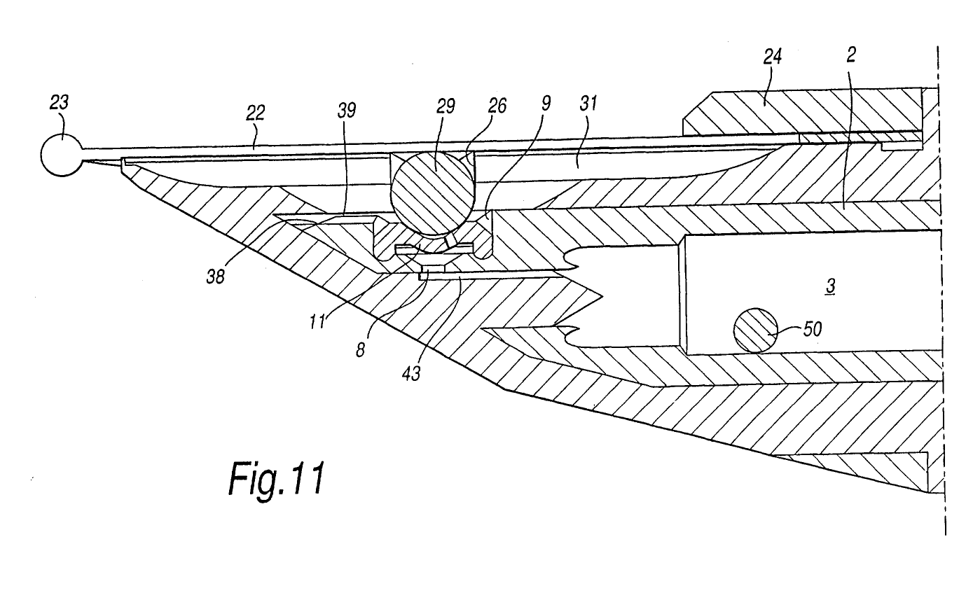

FIG. 11 shows in axial cross-section the cartridge of FIG. 10 inserted into the pen;

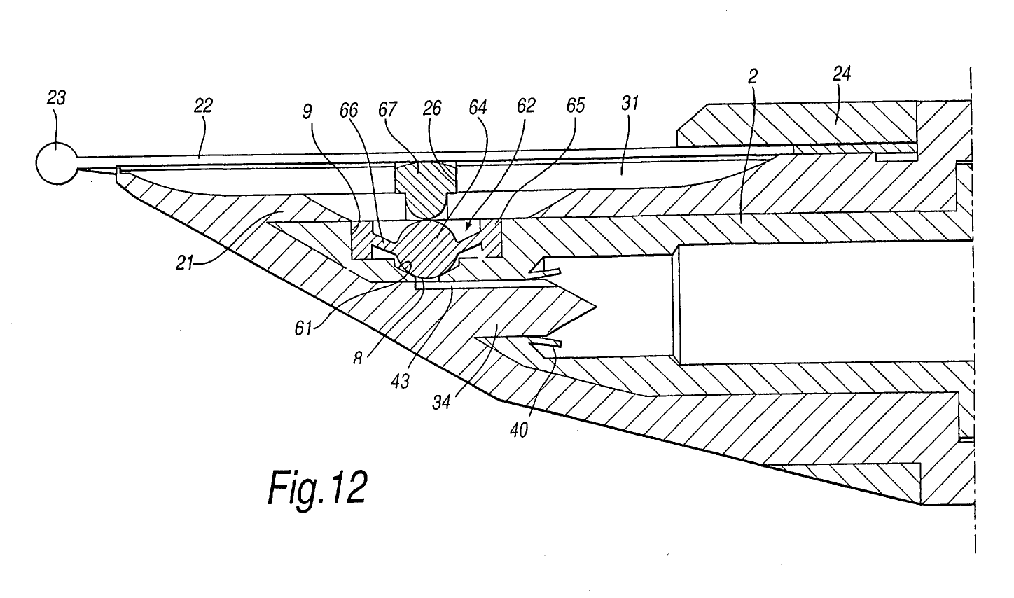

FIG. 12 is an axial cross-section showing an ink cartridge having a valve element in the form of a valve member, the cartridge being shown inserted in a pen with which the cartridge is adapted to be used;

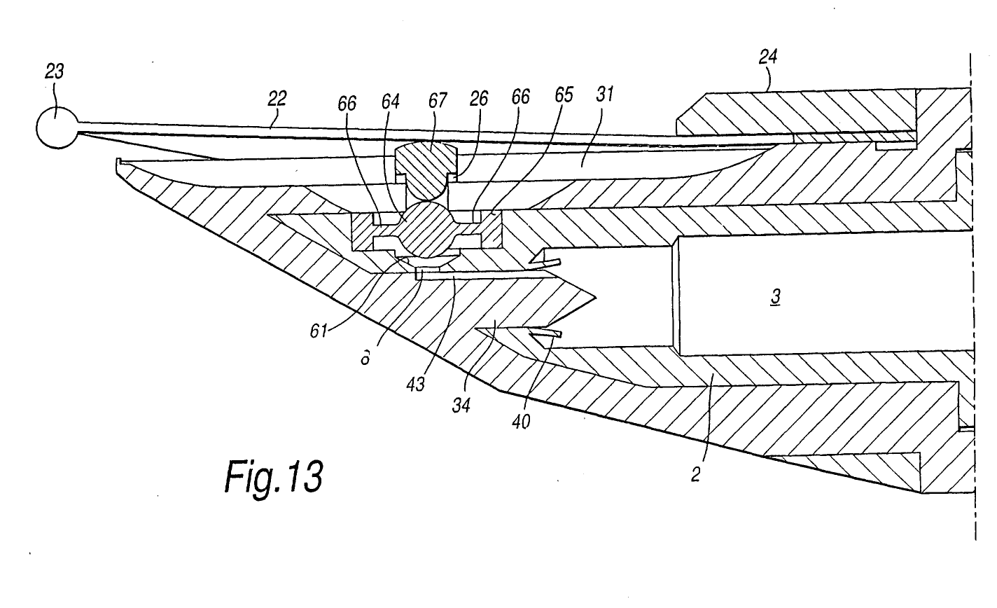

FIG. 13 is an axial cross-section corresponding to FIG. 12; but illustrating the valve in an open condition;

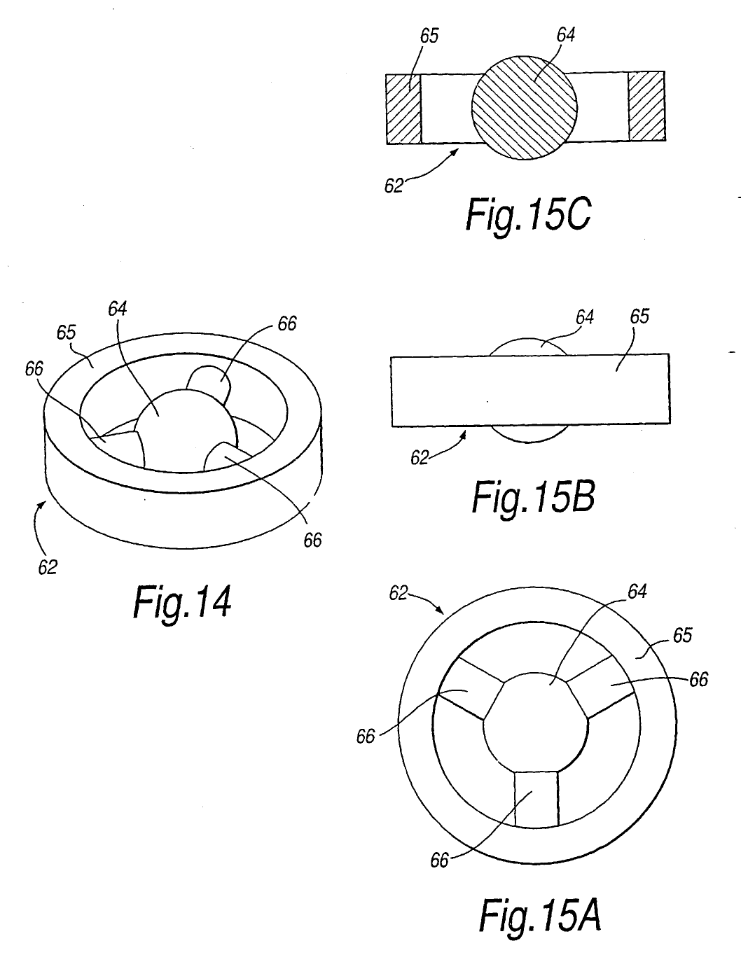

FIG. 14 is an isometric view of the valve element of the ink cartridge included in FIGS. 12 and 13; and

FIGS. 15A, 15B and 15C are a plan, a side elevation and a cross-section, respectively of the valve element of FIG. 14;

Referring initially to FIGS. 1 to 8, an ink cartridge 1 constructed according to the invention has a body 2 shown formed in two parts 2A and 2B and generally cylindrical in configuration. The rear end of the cartridge is not shown in the drawings and it can be closed by an end wall, e.g. integral with the rear body part 2B, or an ink follower, such as a conventional grease plug may be included in order to provide a barrier between the ink contained in the cartridge and ambient air, the ink follower being drawn along die cartridge as the ink is used up in a manner known per se. The cartridge body 2 encloses an ink chamber 3 which is filled with ink, his chamber being initially sealed near the front end of the cartridge by a closure formed by a plug 4 which is sealingly engaged in an axial bore 5 which is open to the front end of the cartridge. The plug 4 is slidable in the cartridge body and can be displaced rearwardly from the position shown in FIG. 1 to open up communication between the chamber 3 and the bore 5 for flow of ink as will be explained in more detail later. An ink discharge port 8 extends through the side wall of the cartridge body, the inner end of the port 8 being open to the bore 5 and the outer end of the port opening at the bottom of an external circular recess 9 formed in the side wall of the body. Accommodated in this recess 9 is a valve element in the form of a valve seat 10 which is moulded from resiliently deformable material. The valve seat, as clearly shown in FIGS. 4-6, consists of a disc 11 in which three segment-shaped apertures 12 are provided and uniformly distributed around the centre of the disc. On its underside the disc 11 has a peripheral rim 14 which gives the valve seat a shallow cup-shape, and the edge of rim 14 sits in an annular groove formed in the bottom of the recess 9 around the ink discharge 8. The pen with which the cartridge is intended to be use has a barrel 20 (FIG. 3) shaped and dimensioned to receive the cartridge which is inserted from the rear, and a feed bar 21 which is shown integral with a front barrel section. A nib 22 having a writing tip 23 is carried on the feed bar 21 and is held in position by a collar 24. The feed bar 21 has a socket 26 which is positioned beneath the nib 22 and in which a valve member in the form of a ball 29 is received. A lip 30 is provided at the inner edge of the socket 26 so that the valve ball 29 is held captive between the nib 22 and the lip 30, but is free to move within the socket A capillary slot 31 extends longitudinally of the feed bar 21 for conducting ink to the underside of the nib 22 for delivery to the writing tip by means for a capillary slit or groove extending along the nib 22. An axially inwardly projecting peg 34 is formed on a front end wall 28 of the pen barrel, this peg having a free end portion 35 of reduced diameter.

FIG. 7A illustrates the ink cartridge 1 in the course of being inserted into the pen of FIG. 3. As the cartridge is pushed forwardly from the position in which it is shown, the peg 34 enters the bore 5 and eventually strikes against the plug 4. As the forward movement of the cartridge 1 continues, the plug 4 is displaced rearwardly relative thereto eventually becoming disengaged from the bore 5 so that communication becomes established between the ink chamber 3 and an annular ink feed duct 36 formed between the reduced diameter portion 35 of the plug and the wall of the bore 5. When fully inserted the peg 34 seals the open end of the bores. Furthermore, during the forward movement of the cartridge, a ramp 38 is provided at the forward edge of the cartridge body 2 is brought into contact with the valve ball 29 and lifts the ball which is then guided along a short groove 39 in the side wall of the cartridge behind the ramp 38 until the valve seat 10 of the cartridge is brought into aligned cooperation with the valve ball which occurs when the cartridge is fully inserted as shown in FIG. 7B. Under the pressure exerted by the nib which is resilient and urges the valve ball 29 inwardly, the disc 11 of the valve seat 10 becomes deformed by the ball 29 which is made of material harder than that of the seat, and a seal is established between the valve ball and the seat so that ink supplied to the discharge port 8 from the chamber 3 via the ink duct 36 is prevented from flowing to the nib 22 through the apertures 12 in the valve seat. When the pen is used, however, the writing tip 23 of the nib is pressed against the paper surface causing the nib 22 to be deflected away from the feed bar 21 as shown in FIG. 8, and he valve ball is then lied by the inherent resilience of the valve seat 10, with the result that the disc 11 becomes flat again so that the sealing cooperation between the ball and seat is interrupted and ink can flow through the seat apertures 12 and into the capillary slot 31 of the feed bar 21 for delivery to the writing tip of the nib. When the nib is lifted from the paper the nib moves back against the feed bar and urges the valve ball 29 inwardly so that the valve becomes closed once again.

In FIGS. 9A and 9B another cartridge and pen are shown in combination and which for the most part are the same as those described with reference to FIGS. 1 to 8. In the drawings the same reference numerals have been used to denote corresponding parts. In place of a sealing plug, the cartridge has a diaphragm or membrane 40, conveniently formed integrally with the body of the cartridge, which serves as a closure between the ink chamber 3 and the bore 5. The peg 34 of the pen has a pointed free end 41 for piercing and rupturing the membrane 40 when the cartridge is introduced into the pen. Also, in this embodiment, instead of having a reduced diameter end portion the peg has a groove 42 which defines a channel 43 for communicating the ink chamber 3 with the discharge port 8.

The ink cartridge illustrated in FIGS. 10 and 11 has a closure plug in the form of a ball 50, which ball becomes dislodged and displaced into the ink chamber 3 by the peg 34 of the pen when the cartridge is inserted into the pen as shown in FIG. 11.

An embodiment of an ink cartridge having a valve element in, the form of a valve member adapted to cooperate with a valve seat formed on the cartridge body is illustrated in FIGS. 12 to 13. The body 2 defines a valve seat 61 around the opening of the ink discharge port 8 at the bottom of the recess 9. The valve element 62 which is disposed in this recess includes a spherical valve member 64, a support ring 65 coaxial with and extending around the valve member 64, and a plurality of radial spring fingers 66 interconnecting the valve member and support ring, there being three such fingers in the illustrated embodiment. The valve element is moulded from a resiliently deformable material, the elasticity in the fingers 66 permitting the valve member 64 to be moved relative to the support ring 65. The pen in this embodiment has a stepped socket 26 in which a piston 67 is slidably received, the outer end of the piston being acted upon and urged inwardly by the pen nib 22. When the cartridge 1 is pushed into the pen, the cartridge closure, shown to be membrane 46 as in FIGS. 9A and 9B, is opened and the nib 22 and piston 67 push the valve member 64 inwardly so that it seals against the valve seat 61 as shown in FIG. 12 so tat ink is unable to flow out through the discharge port 8. In use of the pen, the nib is deflected away from the feed bar 21 under the writing pressure exerted against the tip 23 of the nib allowing the valve member 64 to be moved out of sealing contact with the valve seat 61 due to the bias of the spring fingers 66, and thereby opening up the ink flow path to the nib as may be seen in FIG. 13. When the nib 22 is lifted from the paper the nib moves back against the feed bar 21 driving the piston 67 inwardly so that the valve is closed once again.

Modifications are of course possible to the described embodiments, which are given by way of non-limiting example only, without departing from the scope of the invention as defined the claims which follow.

1. An ink cartridge (1) for a reservoir pen, comprising a body (2) enclosing a chamber (3), an ink port (8) through which, in use, ink delivered from the chamber (3) is discharged from the cartridge (1), and a resilient valve element mounted on the body (2) at the port (8) for controlling flow of ink therethrough, the valve element having an open condition in which the port (8) is opened,
characterized in that the valve element is inwardly resiliently deformable for closing the port.

2. An ink cartridge (1) according to claim 1, wherein the port (8) is formed in a side wall of the body (2) at the bottom of an external recess (9) therein, and the valve element is disposed in the recess (9).

3. An ink cartridge (1) according to claim 1 or 2, wherein the valve element is a moulded element of resiliently deformable material.

4. An ink cartridge (1) according to claim 3, wherein the valve element comprises a valve member (29, 64) for sealing engagement with a valve seat (10, 61).

5. An ink cartridge (I) according to claim 4, wherein the valve seat (61) is defined by the body (2).

6. An ink cartridge (1) according to claim 4 or 5, wherein the valve member (64) is integral with a spring arranged to bias the valve member away from the valve seat (61).

7. An ink cartridge (1) according to claim 6, wherein the spring comprises a plurality of spring fingers (66) radiating from the valve member (64).

8. An ink cartridge (1) according to claim 7, wherein the spring fingers (66) have outer ends connected to a support ring (65) extending around the valve member (64).

9. An ink cartridge (1) according to claim 3, wherein the valve element is a valve seat (10) for cooperation with a valve member (29) mounted in the pen.

10. An ink cartridge (1) according to claim 9, wherein the valve seat (10) comprises a disc (11) with an aperture (12) therein for ink to pass through the disc (11) when the valve is open.

11. An ink cartridge (1) according to any one of the preceding claims wherein the chamber (3) is sealed at the forward end thereof by a closure which is openable to bring the port (8) into communication with the chamber (3).

12. An ink cartridge (1) according to claim 11, wherein a bore (5) is formed at the forward end of the body (2) and the closure is openable by insertion of a peg (34) carried by the pen into the bore (5).

13. An ink cartridge (1) according to claim 12, wherein the closure comprises a membrane (40) and is opened by the peg (34) rupturing the membrane (40).

14. An ink cartridge (1) according to claim 13, wherein the membrane (40) is integral with the body (2).

15. An ink cartridge (1) according to claim 12, wherein the closure comprises a plug (4) and is opened by the peg (34) displacing the plug (4).

16. An ink cartridge (1) according to any one of claims 11 to 15, in combination with a pen adapted to receive the cartridge (1), the pen having a peg (34) for insertion into the bore (5) to open the closure, the peg (34) being arranged to form an ink duct (36) for flow of ink from the chamber (3) to the port (8) and to seal the outer end of the bore (5).

17. An ink cartridge and pen according to claim 16, wherein the peg (34) has a groove (42) extending along the peg (34) to form the ink duct (36).

18. An ink cartridge and pen according to claim 16 or 17, wherein the pen includes a feed bar (21) into which the forward end of the cartridge (1) is inserted, a nib (22) carried on the feed bar (21) and capable of flexing away from the feed bar (21), a socket (26) in the feed bar (21), and a member (29) accommodated in the socket for cooperation with the valve element, the nib (22) being arranged to act on the valve element through the member (29) so that the valve is normally closed and is opened when the nib (29) is deflected away from the feed bar (21).
